(19) United States
(12) Patent Application Publication
(10) Pub. No.: US 2010/0299825 A1
(43) Pub. Date: Dec. 2, 2010

(54) NOZZLE WITH INDEPENDENT FLOW AND PULSE CONTROL

(76) Inventor: Stephen M. Fleischer, Orem, UT (US)

Correspondence Address: JAMES SONNTAG;JAMES SONNTAG, PATENT ATTORNEY, P.O. BOX 9194, SALT LAKE CITY, UT, 84109, US

(21) Appl. No.: 12/472,071

(22) Filed: May 26, 2009

(51) Int. Cl. A61H 33/00

(52) U.S. Cl. 4/541.6

(57) ABSTRACT

A jet for a spa or bathing system that has a water flow modifier, where the water flow modifier is controlled independently from the flow rate of water through the jet.

### CROSS REFERENCE TO RELATED APPLICATIONS

This application is related to U.S. Provisional Patent Application, filed May 22, 2009.

### BACKGROUND OF INVENTION

Jets for spas often have flow modifiers that impart a pulsing, rotating, or like periodic modification of the flow of water from the jet. A characteristic of these jets is that the flow modification increases and decreases with the flow rate through the jet, so that as the jet flow is turned down, the flow modification also decreases. Therefore, it is not possible to obtain a small modification with a high rate of jet flow, or a large modification with a low rate volume jet flow.

### SUMMARY

Described is a jet for spas wherein the jet flow volume and the modification to the jet flow can be controlled separately and independently.

### BRIEF DESCRIPTION OF DRAWINGS

FIG. 1 an exploded view an example jet.

FIG. 2, is a cross-sectional view of an example jet.

FIG. 3 is a back view of a jet plate incorporating a jet as in FIG. 1.

FIG. 4 is a front view of a jet plate incorporating a jet as in FIG. 1.

### DETAILED DESCRIPTION

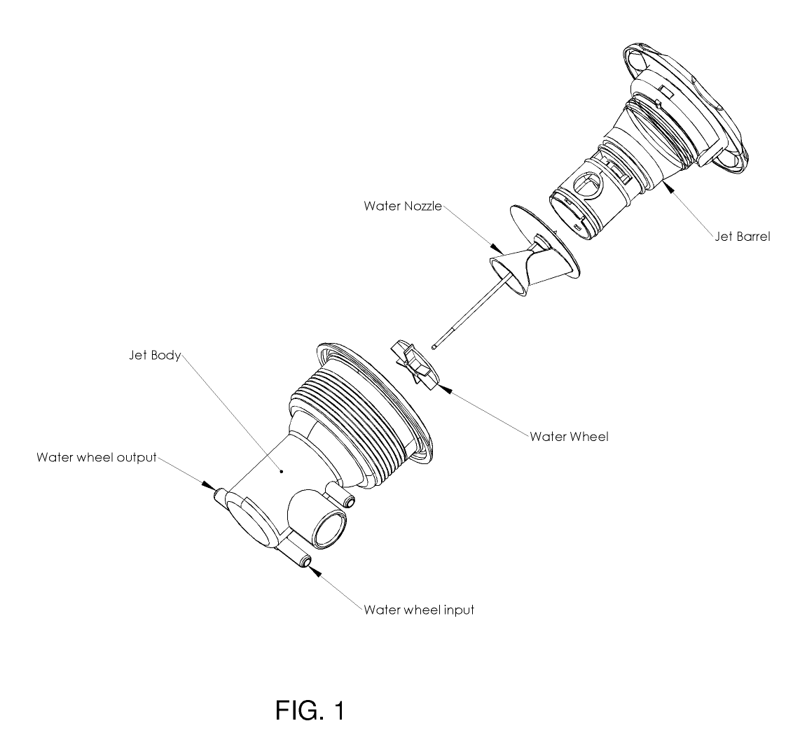

Referring to FIGS. 1 to 4, which are respectively an exploded view of an example of a jet, a cross-section of an example of a jet, a jet plate with mounted jets viewed from the back, and a jet plate with mounted jets viewed from the front.

TABLE
Reference Numbers

| | |
|---|---|
| 101 | jet |
| 103 | jet body |
| 105 | jet water inlet |
| 109 | jet space |
| 111 | water wheel |
| 113 | water wheel space |
| 115 | jet outlet |
| 117 | water wheel plate |
| 119 | water wheel vanes |
| 121 | water wheel shaft |
| 123 | flow modifier |
| 125 | flow director |
| 127 | conduit |
| 129 | outlet plate |
| 131 | axle point |
| 133 | bearing plate |
| 135 | outer barrel |
| 137 | jet barrel |
| 139 | jet plate |
| 141 | water wheel control supply lin [symbol] |
| 143 | control valve |
| 145 | water wheel space inlet |
| 147 | water wheel space outlet |
| 151 | axis |

[symbol]

indicates data missing or illegible when filed

An exemplary jet 101 comprises a jet body 103 with ports for jet water inlet, and jet air inlet. The jet water inlet and optional jet air inlet communicate with a jet space within the jet body which in turn communicates with a jet outlet that directs mixed water and air from the jet space into the spa.

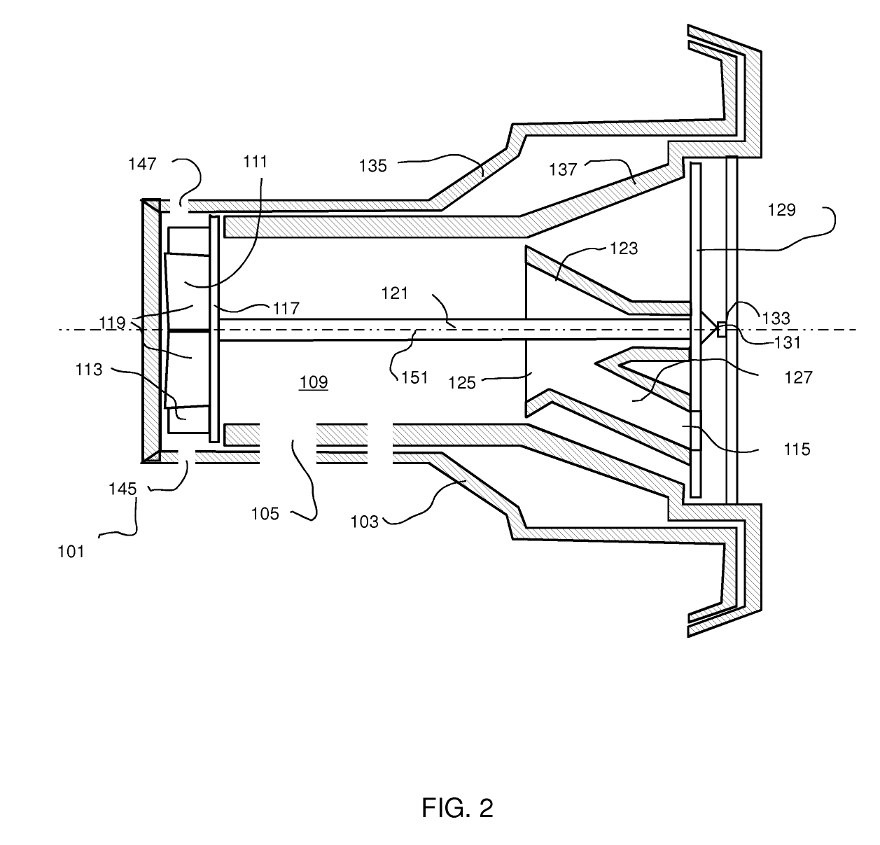

Within the jet body is a water or turbine wheel in a water wheel space with ports for water wheel input and water wheel output. Although there is no need for a complete water seal, structure is provided to minimize water flow between the jet space and the water wheel space. This is so that control of the speed of rotation of the water wheel is essentially independent of the flow rate of water and air through the jet space to the jet outlet. Instead the rotational speed of the water wheel depends mostly upon water flowing from the water wheel inlet, through the water wheel space, and out through the water wheel outlet. The the examples shown in FIGS. 1 and 2, the water wheel space is isolated from the jet space by a water wheel plate that supports water wheel vanes. The plate fits closely to the edges of the jet body, but still allowing the plate and water wheel to rotate. Other constructions would be suitable, such as for example, a stationary wall or partition, or a rotating plate separate from the water wheel.

The water wheel comprises vanes, so that as the water flows through the water wheel space it causes the water wheel, which is mounted on a shaft, to rotate the water wheel about an axis. The function of the water wheel shaft is not only to support the water wheel as it rotates, but also to transmit the rotary motion of the wheel to a flow modifier. Other systems for accomplishing the same functions are contemplated, such any combination of rotating plates mounted circumferentially, rotating cylinders, gear trains, and the like.

The water wheel shaft rotates a flow modifier. A flow modifier functions to modify the flow of water and air as it exits the jet outlet. Usually the modifying involves imparting a rotary or pulse action to the flow. In the present jet the flow modifier is driven and regulated by the rotation of the water wheel, and is accordingly independent of the flow rate of air, water, or air and water together through the jet. Accordingly, it is possible to have a low jet flow, with a significant modification of the jet, or a high jet flow with little modification of the jet. This contrasts with previous jets where the modification of the jet flow is powered by the water and/or air flow through the jet where it was only possible to increase the flow modification effect by simultaneously increasing the flow rate.

The flow modifier in the present example is a nozzle mounted with a jet outlet on the rotating shaft, so that as the water wheel turns the jet outlet moves around the axis in a revolving motion. The nozzle includes a director that directs flow from the jet space into a conduit leading to the jet outlet. The jet outlet is offset from the shaft and revolves around the axis of the shaft as the water wheel, and the nozzle rotate. The jet outlet is mounted on a plate that fits closely at its edges to the jet body (but allows rotation of the plate) to minimize any flow from the jet except through the jet outlet. Also in this example, the shaft terminates as a point extending from the plate, which bears against a dimpled bearing plate. Pressure from inside the jet body causes the point to bear against the bearing plate, which maintains the shaft in place as it spins. Any other system for mounting rotating elements and maintain their radial and longitudinal alignment is contemplated, such as sleeve bearings.

The flow modifier can be, for example, a rotating jet outlet of any suitable construction, including that illustrated. The flow modifier may be any other suitable structure that modifies the flow in a way that increases comfort for a bather, such as by rotating or revolving a jet outlet, or pulsing the flow of water from the jet. These include, for example, structures with rotating apertured disks, single or multiple rotating or revolving outlets, moving paddles, ______ [Please add to this list as appropriate.]

In the example illustrated in FIGS. 1 and 2, the jet body is in two pieces, and outer barrel and a jet barrel. This was to ease the assembly of the jet. To assemble the water wheel is inserted into the outer barrel. The jet barrel is then inserted over the water wheel, followed by insertion of the shaft/nozzle assembly through the jet barrel and into the water wheel. Structure containing the bearing plate is then attached to the jet barrel.

However, it is contemplated that any number of the stationary elements of the jet, be constructed separately or integrally. For example, in FIG. 1, the outer barrel, and the jet barrel could be constructed as an integral unit with modification of the rotating parts to enable their assembly. Likewise, any number of the rotating elements can be constructed separately or integrally. For example, the water wheel shaft and flow modifier can be integrated. This is a design choice, based in part on manufacturing, assembly, and cost factors.

The jets can be used in any suitable spa construction. Generally these comprise a water containment, with jets in the walls of the containment directing water and/or air into the containment. Suitable control valves and/or pumps are provided to control flow through the jets to achieve a desired level of comfort for a bather.

There are also control valves separate from those for the jets for the water wheel. These control valves can be any suitable fluid valve construction, or a functional equivalent, such as pumps controlled by a speed controller. One or more of such control valves can be mounted in any suitable location accessible to the bather to allow control of the modification of the jet, which may be the speed of pulsation or rotation of jet stream. A separate water supply from the jet water supply is provided to the control valves, which then direct water to the inlet to the water wheel space. If required, conduits or tubes are also provided to direct water exiting from the water wheel space outlet.

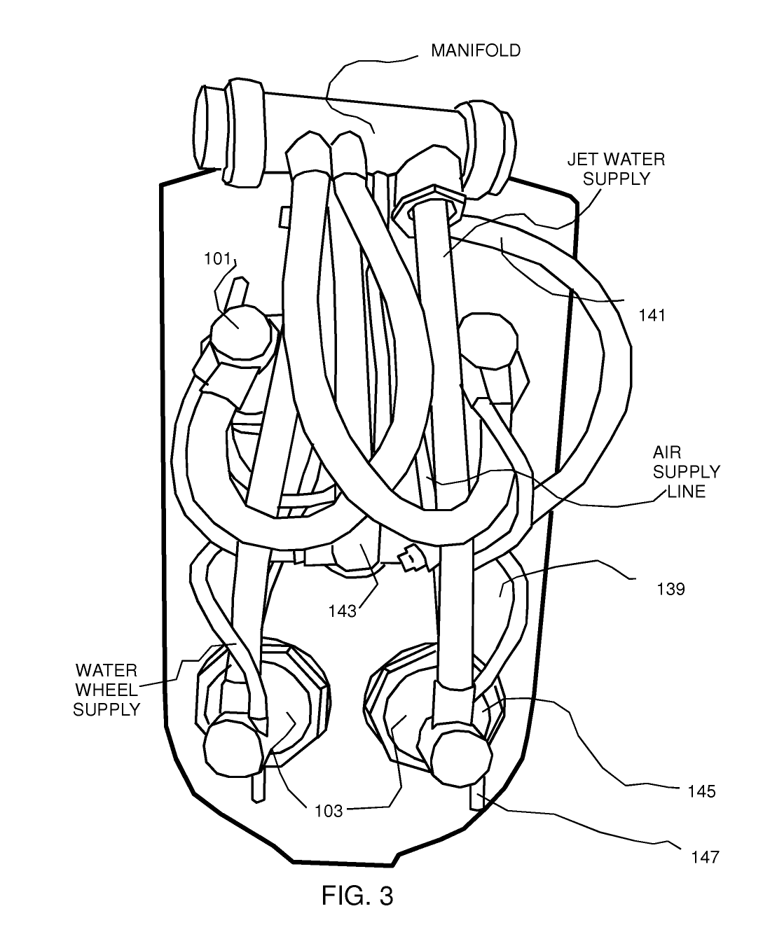

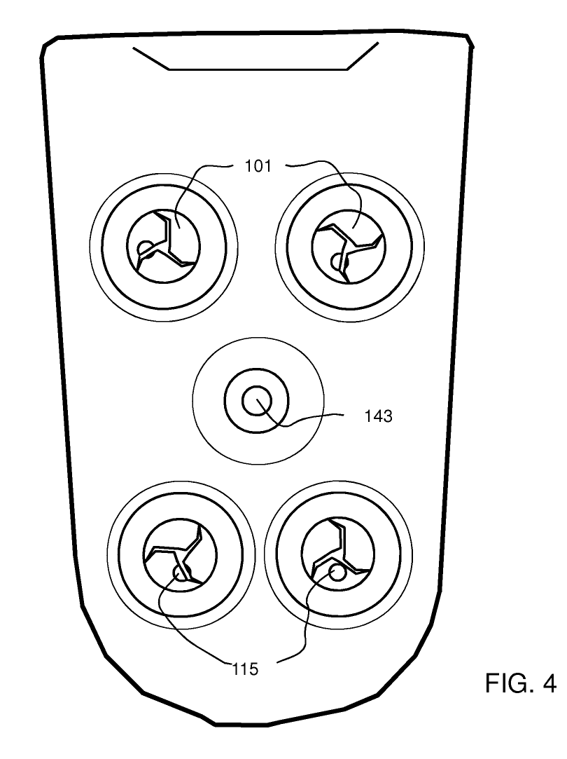

A spa construction that can be adapted for inclusion of the present nozzles is the JetPak™ system described in U.S. Pat. Nos. 6,543,067, 5,754,989, 6,092,246, 6,000,073, 5,987,663, 6,256,805, which are hereby incorporated by reference. Referring particularly to FIGS. 3 and 4, in this system, jets are mounted on jet plates, which are then mounted in the spa containment at bathing stations. Water supply is provided by a water manifold. On the manifold are water ports for jet nozzles, and water ports for jet water wheels. A water wheel control supply line supply directs pressurized water from the manifold to a control valve. From the control valve separate water wheel space supply lines direct water to the water wheel space inlet. No lines are attached to the water wheel space outlet since with the JetPak system, water can flow directly from the jet into the containment behind the jet plate. Other spa constructions may require a line from the outlet to the containment.

While this invention has been described with reference to certain specific embodiments and examples, it will be recognized by those skilled in the art that many variations are possible without departing from the scope and spirit of this invention, and that the invention, as described by the claims, is intended to cover all changes and modifications of the invention which do not depart from the spirit of the invention.

1. A jet for a bathing system comprising:
a jet body;
a jet space within the jet body that communicates with a water inlet and a jet outlet;
a wheel space within the jet body with a wheel disposed to rotate as water flows through the wheel space,
the wheel space and jet space sufficiently isolated from each other such that water flow in the jet space does not significantly affect the rotation of the wheel;
a flow modifier operably connected to the wheel, such that rotation of the wheel causes a modification of water flow through the jet outlet.

2. The jet as in claim 1 wherein the water supply for the wheel space is independent from the water supply for the jet space, such that the water supply for the wheel space can be controlled independently from the water supply for the jet space.

3. A jet plate comprising:
a plate upon which are mounted one or more jets;
at least one of the jets being a controlled jet comprising: (1) a jet body; a jet space within the jet body that communicates with a water inlet and a jet outlet; (2) a wheel space within the jet body with a wheel disposed to rotate as water flows through the wheel space, the wheel space and jet space sufficiently isolated from each other such that water flow in the jet space does not significantly affect the rotation of the wheel; (3) a flow modifier operably connected to the wheel, such that rotation of the wheel causes a modification of water flow through the jet outlet;
a control valve with a water supply line separate from the jet supply lines and water supply line to the water wheel space.

4. A jet comprising:
jet water supply for directing water flow to a jet outlet;
water flow modifier configured to impart a periodic modification to water flow from the jet outlet;
independent water supply that is independent from flow rate of water from the jet outlet, where the flow modifier is driven by flow of water from the independent water supply such that the periodic modification is independent from the flow rate of water through the jet outlet.

5. A jet as in claim 4 wherein the independent water supply includes a water flow controller to control the rate of water from the independent water supply and thereby independently control the periodic modification from the flow rate of water through the jet outlet.

6. A jet as in claim 4 wherein the flow modifier is driven by the water supply by a wheel the rotates in response to the flow of water from the independent water supply.

7. A jet as in claim 5 wherein the flow modifier is driven by the water supply by a wheel the rotates in response to the flow of water from the independent water supply as controlled by the water flow controller.

8. A jet as in claim 7 wherein the jet includes a jet space from which water flows to the jet outlet, and the wheel is disposed in a wheel chamber sufficiently water sealed from the jet space to provide the independent periodic modification to water flow from the jet.
